(19) United States
(12) Patent Application Publication
(10) Pub. No.: US 2016/0371366 A1
(43) Pub. Date: Dec. 22, 2016

(54) Contact Management Method and Apparatus

(71) Applicant: TENCENT TECHNOLOGY (SHENZHEN) COMPANY LIMITED, Shenzhen, Guangdong (CN)

(72) Inventors: Yan Gao, Shenzhen (CN); Chuan Chen, Shenzhen (CN); Yading Yue, Shenzhen (CN)

(73) Assignee: TENCENT TECHNOLOGY (SHENZHEN) COMPANY LIMITED, Shenzhen (CN)

(21) Appl. No.: 15/104,999

(22) PCT Filed: Apr. 30, 2015
(86) PCT No.: PCT/CN2015/077934

§ 371 Date: Jun. 16, 2016

(30) Foreign Application Priority Data
Apr. 30, 2014 (CN) 201410179400.3

(51) Int. Cl. G06F 17/30

(52) U.S. Cl. CPC G06F 17/30604; G06F 17/30598

(57) ABSTRACT

A contact management method and apparatus are described. The method includes: calculating a score of interaction activity between a user and a contact according to an interaction measure, interaction frequency, a time attenuation factor, and a preset weight of each interaction type of the user and the contact, and a simultaneous satisfaction degree of the interaction types; identifying a relation chain type of the user and the contact, and querying a preset score table to obtain a score of the relation chain type; calculating a score of relational closeness between the user and the contact; and managing the contact according to the score of the relational closeness.

### FIELD OF THE TECHNOLOGY

Specific embodiments of the present invention relate to the field of network communications technologies, and in particular, to a contact management method and apparatus.

### BACKGROUND OF THE DISCLOSURE

With the rapid development of computer technologies and network technologies, instant messaging applications and social applications have been gradually integrated into people's daily lives, and people accumulates increasingly more social relation chains in the instant messaging applications and the social applications such as QQ and Friendster. However, such a kind of social relation chains has an obvious time feature. As time flies and the world changes, a contact with whom a user frequently chats before may have become a stranger after several years. When facing a long list of contacts, the user often cannot remember who a contact is, but the user may frequently interact with a lately added contact. Although some contacts are always less frequently interacting and communicating with the user, the contacts are people the user cares about in real life, for example, relatives.

Therefore, as the user adds increasingly more contacts, it is necessary to manage the contacts according to relational closeness between the user and the contacts. An existing method for measuring relational closeness between a user and a contact generally is obtaining, through simple weighting calculation, a score of the relational closeness between the user and the contact according to the number of interactions of interaction types, such as @, reposting, and commenting, of the user and the contact, and then measuring the relational closeness between the user and the contact according to the score, which is obtained through calculation, of the relational closeness.

However, the score of the relational closeness is limited by a weight of each interaction type. If a weight of an interaction type is 0, no matter how large the number of interactions of the interaction type is, an obtained score of the relational closeness may also be decreased by the interaction type. Therefore, if it is hoped that the score of the relational closeness is large, it is required that the number of interactions of each interaction type be large. However, in fact, to measure the relational closeness between the user and the contact to be high, not all interaction types need to be very active, and it may be considered that the relational closeness between the user and the contact is high provided that only one or several interaction types are active.

Second, in such a method of measuring relational closeness, only the number of interactions of each interaction type is considered, and interaction frequency of each interaction type and a time attenuation effect of an interaction are not considered. For example, the user may interact with the contact multiple times in one day (for example, comment each other multiple times in a network war of words), but it cannot be considered that the relational closeness between the user and the contact is high. Interaction frequency further needs to be considered, and an interaction situation between the user and the contact within a period of time is observed. Different intervals between interaction times and a current time have different effects on measuring the relational closeness. If the numbers of interactions are simply added up, an impact of a time factor on measuring the relational closeness may be ignored.

In addition, in such a method of measuring relational closeness, a real offline relation chain type of the user and the contact is not considered. If the user and the contact are really intimate offline, even though the user and the contact interact less frequently or even the user and the contact do not interact, flexibility processing still needs to be performed on measurement of the relational closeness according to a relation chain type of the user and the contact.

### SUMMARY

In view of this, it is necessary to provide a contact management method and apparatus, which can be used to help a user tease out a social relation chain, so as to facilitate information recommendation to the user.

A contact management method is applied to a server, the server including one or more processors, a memory, and a program instruction stored in the memory, and the program instruction being executed by the one or more processors, and includes the following steps: calculating a score of interaction activity between a user and a contact according to an interaction measure, interaction frequency, a time attenuation factor, and a preset weight of each interaction type of the user and the contact, and a simultaneous satisfaction degree of the interaction types; identifying a relation chain type of the user and the contact, and querying a preset score table to obtain a score of the relation chain type; calculating a score of relational closeness between the user and the contact according to the score of the interaction activity and the score of the relation chain type with reference to a simultaneous satisfaction degree of the interaction activity and the relation chain type, and preset weights of the interaction activity and the relation chain type; and managing the contact according to the score of the relational closeness.

A contact management apparatus includes: one or more processors; a memory; and one or more program modules, stored in the memory, and executed by the one or more processors, the one or more program modules including: a first calculation module, configured to calculate a score of interaction activity between a user and a contact according to an interaction measure, interaction frequency, a time attenuation factor, and a preset weight of each interaction type of the user and the contact, and a simultaneous satisfaction degree of the interaction types; an identification module, configured to identify a relation chain type of the user and the contact, and query a preset score table to obtain a score of the relation chain type; a second calculation module, configured to calculate a score of relational closeness between the user and the contact according to the score of the interaction activity and the score of the relation chain type with reference to a simultaneous satisfaction degree of the interaction activity and the relation chain type, and preset weights of the interaction activity and the relation chain type; and a management module, configured to manage the contact according to the score of the relational closeness.

According to the contact management method and apparatus in the present disclosure, interaction activity between a user and a contact is obtained by comprehensively considering an interaction measure, interaction frequency, and a time attenuation effect of each interaction type of the user and the contact, and a simultaneous satisfaction degree of the interaction types; relational closeness between the user and the contact is measured with reference to a simultaneous satisfaction degree of a relation chain type of the user and the contact and the interaction activity; and the contact is managed according to the relational closeness, which can help the user tease out a social relation chain, so as to facilitate information recommendation to the user.

To make the foregoing and other objectives, features, and advantages of the present disclosure clearer and more comprehensible, the following uses preferred embodiments for detailed descriptions with reference to the accompanying drawings.

### BRIEF DESCRIPTION OF THE DRAWINGS

The aforementioned features and advantages of the disclosed embodiments as well as additional features and advantages thereof will be more clearly understood hereinafter as a result of a detailed description of preferred embodiments when taken in conjunction with the drawings.

The following briefly describes the accompanying drawings included for describing the embodiments or the prior art. The accompanying drawings in the following descriptions merely show some embodiments, and a person of ordinary skill in the art can derive other drawings from these accompanying drawings without creative efforts.

FIG. 1 is a structural block diagram of a server;

FIG. 2 is a schematic diagram of an environment to which a contact management method is applied according to an embodiment of the present invention;

FIG. 3 is a flowchart of a contact management method according to an embodiment of the present invention;

FIG. 4 is a detailed flowchart of step S1 in FIG. 3;

FIG. 5 is an exemplary curve diagram of an exponential attenuation function;

FIG. 6 is an exemplary curve diagram of an exponential attenuation function on which arc tangent transformation is performed; and

FIG. 7 is a block diagram of a contact management apparatus according to an embodiment of the present invention.

### DESCRIPTION OF EMBODIMENTS

To further explain the technical means used in the present disclosure for achieving the intended objectives and the effects thereof, specific implementation manners, structures, features, and effects of the present disclosure are described in detail below with reference to the accompanying drawings and preferred embodiments.

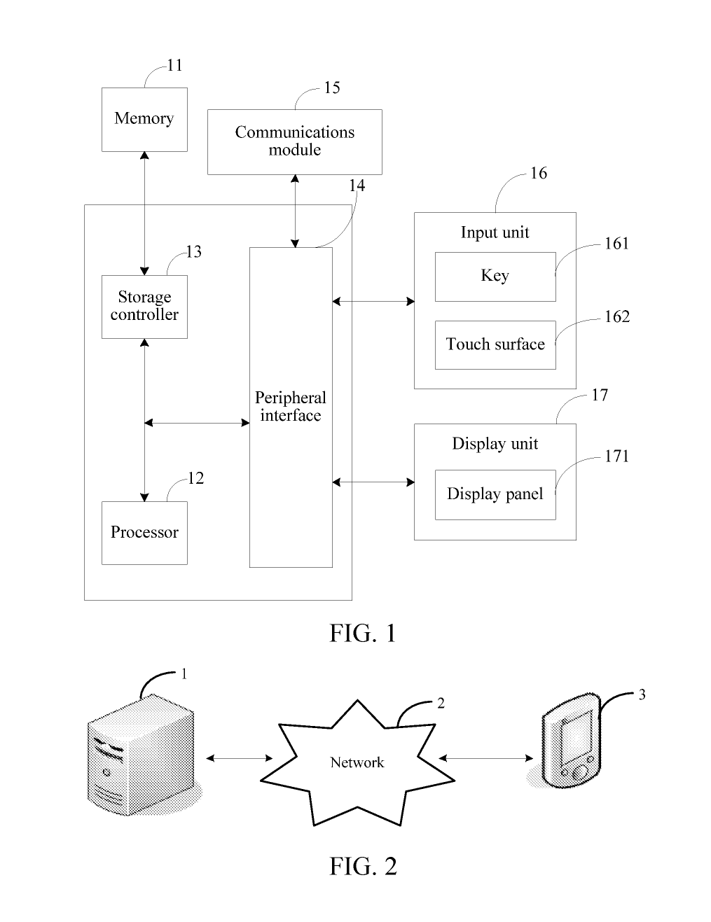

FIG. 1 shows a structural block diagram of a server. As shown in FIG. 1, a server 1 includes one or more memories 11 (only one memory is shown in the figure), a processor 12, a storage controller 13, a peripheral interface 14, a communications module 15, an input unit 16, and a display unit 17. These components communicate with each other by using one or more communication buses/signal lines.

It may be understood by a person of ordinary skill in the art that the structure shown in FIG. 1 is merely exemplary, and does not constitute a limitation to the structure of the server 1. For example, the server 1 may also include more or fewer components than those shown in FIG. 1, or have a configuration different from that shown in FIG. 1. The components shown in FIG. 1 may be implemented by hardware, software, or a combination thereof.

The memory 11 may be configured to store a software program and module, such as a program instruction/module corresponding to a contact management method and apparatus in the embodiments of the present invention. The processor 12 executes different functional applications and performs data processing by running the software program and module that are stored in the memory 11, thereby implementing the contact management method.

The memory 11 may include a high-speed random access memory (RAM), and may also include a non-volatile memory, for example, one or more magnetic storage apparatuses, flash memories or other non-volatile solid-state memories. In some embodiments, the memory 11 may further include memories remotely disposed relative to the processor 12, and these remotely disposed memories may be connected to the server 1 by using a network. An example of the network includes, but is not limited to, the Internet, an intranet, a local area network, a mobile communications network, or a combination thereof. The processor 12 and other possible components may access the memory 11 under the control of the storage controller 13.

The peripheral interface 14 couples various input/output apparatuses to the processor 12 and the memory 11. The processor 12 runs various software and instructions in the memory 11, so as to perform different functions of the server 1 and perform data processing.

The communications module 15 is configured to communicate with a communications network or another device. Specifically, the communications module 15 may be, for example, a network adapter. The network adapter, as an interface connecting a computer and a transmission medium in a local area network, is used for implementing physical connection and electronic signal matching between the network adapter and the transmission medium in the local area network, so as to establish a local area network and connect the local area network to the Internet, and communicate with various networks, such as a local area network, a metropolitan area network, and a wide area network. The network adapter may include various existing circuit elements for performing the foregoing functions, such as a processor and a memory (including a ROM and a RAM).

The input unit 16 may be configured to receive input character information, and generate a keyboard, mouse, joystick, optical, or track ball signal input related to the user setting and function control. Specifically, the input unit 16 may include a key 161 and a touch surface 162. The key 161 may include, for example, a character key for inputting a character, and a control key for triggering a control function. An example of the control key includes a “home screen” key, an on/off key, a shooting key, and the like. The touch surface 162 may collect a touch operation of a user on or near the touch surface (such as an operation of a user on or near the touch surface 162 by using any suitable object or accessory, such as a finger or a stylus), and drive a corresponding connection apparatus according to a preset program. Optionally, the touch surface 162 may include two parts: a touch detection apparatus and a touch controller. The touch detection apparatus detects a touch position of the user, detects a touch signal generated by the touch operation, and transfers the signal to the touch controller. The touch controller receives the touch signal from the touch detection apparatus, converts the touch signal into touch point coordinates, and sends the touch point coordinates to the processor 12. Moreover, the touch controller can receive and execute a command sent from the processor 12. In addition, the touch surface 162 may be may be a resistive, capacitive, infrared, or surface sound wave type touch surface. In addition to the touch surface 162, the input unit 16 may further include another input device. The another input device includes, but is not limited to, one or more of a physical keyboard, a track ball, a mouse, and a joystick.

The display unit 17 is configured to display information input by the user, information provided for the user, and various graphical user interfaces of the server 1. The graphical user interfaces may be formed by a graph, a text, an icon, a video, or any combination thereof. In an embodiment, the display unit 17 includes a display panel 171. The display panel 171 may be, for example, a liquid crystal display (LCD) panel, an organic light-emitting diode (OLED) display panel, an electro-phoretic display (EPD) panel, or the like. Further, the touch surface 162 may be disposed on the display panel 171, so as to form a whole with the display panel 171.

FIG. 2 is a schematic diagram of an environment to which a contact management method is applied according to an embodiment of the present invention. In this embodiment, the contact management method is applied to the server 1, and the server 1 performs network communication with a terminal 3 by using a network 2. The server 1 may include one or more servers, and certainly, the server 1 may also be a virtual cloud computing module. A specific example of the terminal 3 includes, but is not limited to, a desktop computer, a portable computer, a mobile phone, a tablet computer, a person digital assistant, or another similar computing apparatus. The network 2 may use any network connection manner, such as the Internet, a mobile Internet (such as 2G and 3G networks provided by a telecommunications operator), and a local area network (wired or wireless).

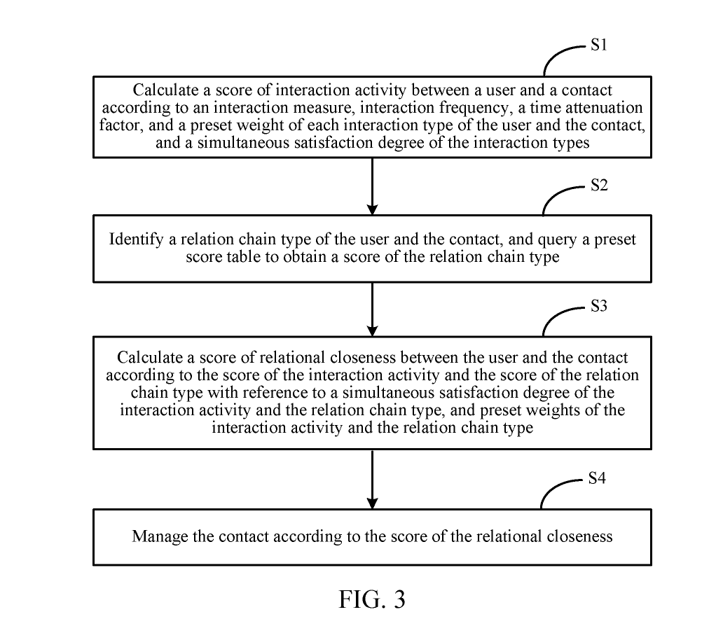

Referring to FIG. 3, an embodiment of the present invention provides a contact management method. The contact management method includes the following steps:

Step S1: Calculate a score of interaction activity between a user and a contact according to an interaction measure, interaction frequency, a time attenuation factor, and a preset weight of each interaction type of the user and the contact, and a simultaneous satisfaction degree of the interaction types. In another embodiment, either one of the time attenuation factor and the preset weight may be selected as a condition for calculating the score of interaction activity.

Step S2: Identify a relation chain type of the user and the contact, and query a preset score table to obtain a score of the relation chain type.

Step S3: Calculate a score of relational closeness between the user and the contact according to the score of the interaction activity and the score of the relation chain type with reference to a simultaneous satisfaction degree of the interaction activity and the relation chain type, and preset weights of the interaction activity and the relation chain type.

Step S4: Manage the contact according to the score of the relational closeness.

According to the contact management method, interaction activity between a user and a contact is obtained by comprehensively considering an interaction measure, interaction frequency, and a time attenuation effect of each interaction type of the user and the contact, and a simultaneous satisfaction degree of the interaction types; relational closeness between the user and the contact is measured with reference to a simultaneous satisfaction degree of a relation chain type of the user and the contact and the interaction activity; and the contact is managed according to the relational closeness, which can help the user tease out a social relation chain, so as to facilitate information recommendation to the user, for example, to recommend a friend to the user.

In some embodiments, implementation details of the foregoing steps of the method are described as follows:

The user in step S1 may be a user that obtains a valid login account by applying to a server 1, and therefore can log in to the server 1 on a client by using the login account. The client runs in a terminal 3, and the client may be, for example, a client of an instant messaging tool, such as QQ, Skype, WeChat, or Fetion, or may be a client of a social site, such as Renren or Tongchengwang. The instant messaging tool or the social site is disposed in the server 1. The contact may be a contact that is successfully added after the user sends a contact adding request to the server 1 after the user logs in to the server 1. The user may perform various interaction operations with the contact, for example, initiate a session with the contact, @ the contact, and repost or comment content posted by the contact.

In step S1, the contact may be randomly selected from a contacts list of the user, or the contact may be selected from the contacts list of the user by using a traversal method. In this embodiment, the interaction types of the user and the contact include a one-to-one interaction, a one-to-many interaction, and a social site interaction. Specifically, the one-to-one interaction refers to one-to-one instant communication between the user and the contact, such as a one-to-one session in QQ or WeChat. The one-to-many interaction refers to instant communication between the user and group members. The group members include the contact, and the group may be, for example, a QQ group or a discussion group. When the number of the group members is less than a preset value, for example, 5, an interaction between the user and the group members may be converted into an interaction between the user and the contact. The social site interaction refers to an interaction performed between the user and the contact in a social site such as Friendster or Qzone, for example, an interaction of commenting a log, an album, a diary, and the like, and an interaction of leaving a message on a message board, sending a gift, visiting, and liking.

In step S1, the interaction measure and the interaction frequency of each interaction type of the user and the contact need to be collected, and the collected interaction measure and interaction frequency are stored in a database. In this embodiment, an index of the interaction measure of the interaction type is the number of daily interactions or the number of monthly interactions. Specifically, an interaction measure of the interaction type in a current month (that is, the first day of the current month to today) is represented as the number of daily interactions, and an interaction measure of the interaction type in months before the current month (such as the last month and the month before the last month, 6 months before the current month is used by default) is represented as the number of monthly interactions. An index of the interaction frequency of the interaction type is the number of monthly interaction days.

For example, using an example in which the interaction type is the one-to-one interaction, the storage structure of an interaction measure and an interaction frequency of the one-to-one interaction in the database is shown in the following table:

| | | | | | | | | | |
|---|---|---|---|---|---|---|---|---|---|
| Date in a | 25 | 24 | 23 | 22 | 21 | 20 | . . . | 2 | 1 |
| current month | | | | | | | | | |
| (May) | | | | | | | | | |
| The number of | | | | | | | | | |
| daily | | | | | | | | | |
| interactions | | | | | | | | | |
| Previous | April | March | February | January | December | November | | | |
| months | | | | | | | | | |
| The number of | | | | | | | | | |
| monthly | | | | | | | | | |
| interactions | | | | | | | | | |
| and the | | | | | | | | | |
| number of | | | | | | | | | |
| monthly | | | | | | | | | |
| interaction | | | | | | | | | |
| days | | | | | | | | | |

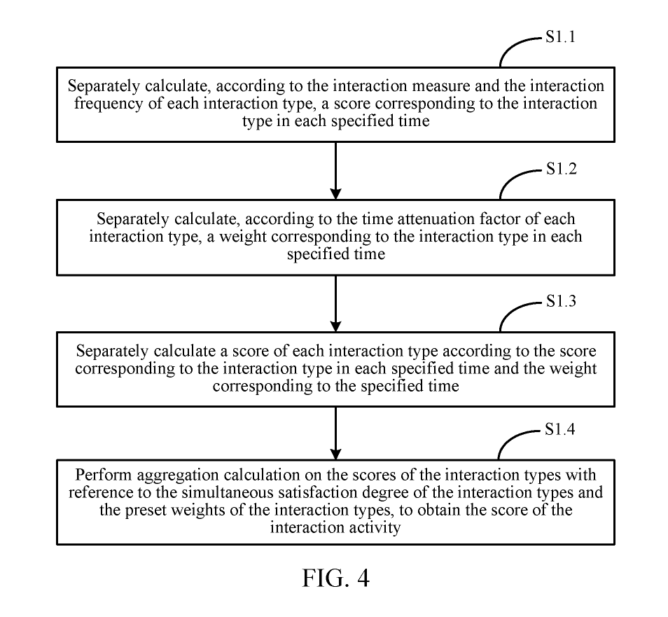

Referring to FIG. 4, step S1 of calculating a score of interaction activity may be specifically divided into the following steps:

Step S1.1: Separately calculate, according to the interaction measure and the interaction frequency of each interaction type, a score corresponding to the interaction type in each specified time.

Step S1.2: Separately calculate, according to the time attenuation factor of each interaction type, a weight corresponding to the interaction type in each specified time.

Step S1.3: Separately calculate a score of each interaction type according to the score corresponding to the interaction type in each specified time and the weight corresponding to the specified time.

Step S1.4: Perform aggregation calculation on the scores of the interaction types with reference to the simultaneous satisfaction degree of the interaction types and the preset weights of the interaction types, to obtain the score of the interaction activity.

In step S1.1, for a current month, a score corresponding to each specified time is a score corresponding to each day. For months before the current month, a score corresponding to each specified time is a score corresponding to each of the months before the current month. Assuming that for the current month, the score corresponding to each day is S(D), and for months before the current month, the score corresponding to each month is S(M), a calculation formula of S(D) and S(M) is as follows:

S(D)=arctan(a*ni),

where ni is the number of interactions in an i^{th} day of the current month, and a is a parameter; because the numbers of interactions in specific days are large, arctan may be used for narrowing down a score gap caused by the large numbers of interactions, and a may be used for adjusting a narrowing degree; and

S(M)=A*[(b*di)̂0.5+c]+B*arctan(a*mi),

where mi is the number of interactions in an i^{th} month, di is the number of interaction days in the i^{th} month, and a, b, and c are parameters; arctan may be used for narrowing down a score gap caused by the large numbers of interactions, and a may be used for adjusting a narrowing degree; b is used for controlling an inflection point of a parabolic function (b*di)̂0.5+c, where after the inflection point, an increase of the parabolic function slows down; C is used for controlling a starting score; A is a weight of the interaction frequency, and B is a weight of the interaction measure.

The weight A of the interaction frequency and the weight B of the interaction measure may be obtained by using an analytic hierarchy process (AHP). Specifically, steps of determining A and B by using the AHP are described as follows: 1. Give out questionnaire surveys, and obtain a candidate set of pairwise comparison matrixes; 2. Perform consistency check, and remove a pairwise comparison matrix that does not meet consistency; 3. Calculate multiple weight vectors of the interaction frequency and the interaction measure according to a pairwise comparison matrix meeting consistency, and vote on the multiple weight vectors, to obtain the weight A of the interaction frequency and the weight B of the interaction measure.

In step S1.2, for the current month, a weight corresponding to each specified time is a weight corresponding to each day in the current month. For the months before the current month, a weight corresponding to each specified time is a weight corresponding to each of the months before the current month. The time attenuation factor is used for synthesizing a time attenuation property in the score corresponding to each specified time of each interaction type, that is, as an interval from an interaction time to a current time increases, the weight of the score corresponding to the specified time gradually decreases.

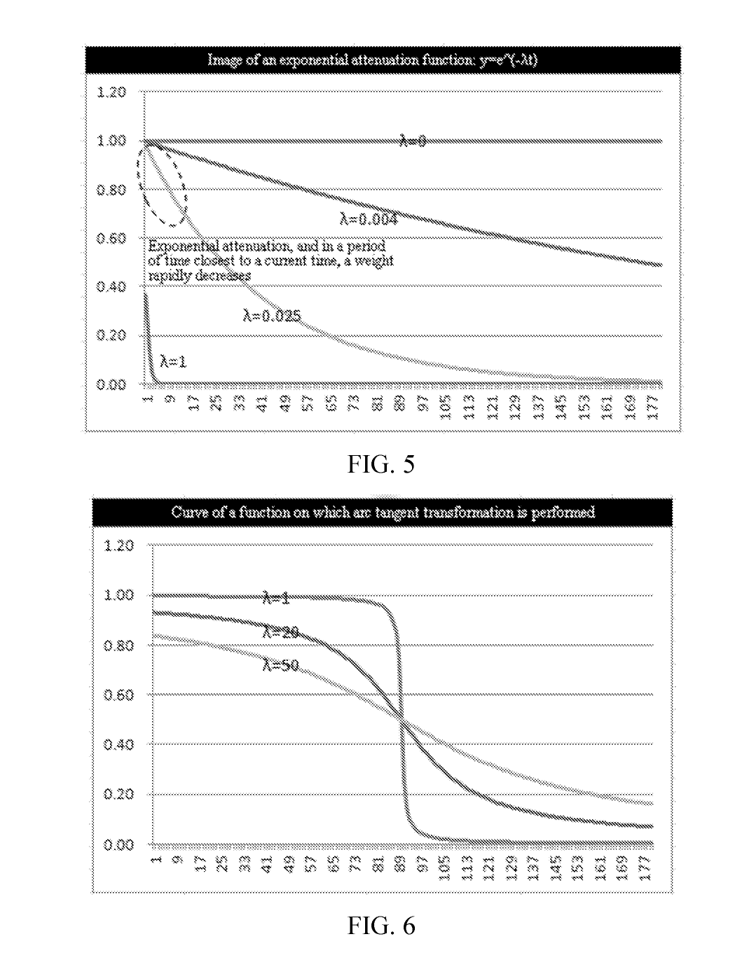

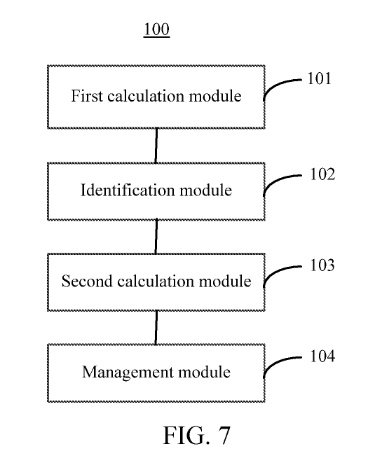

Specifically, for a commonly used time attenuation manner, refer to an element half life, which is mostly an exponential attenuation function: y=ê(−λt), where λ is an attenuation factor, and t is a time variable. A curve of the exponential attenuation function rapidly decreases in a period of time closest to the current time, which is shown in FIG. 5. However, for measuring the relational closeness, as time attenuation is not as sensitive as element attenuation, it is generally hoped that a weight corresponding to a specified time slowly decreases in a period of time closer to the current time instead of rapidly decreasing. Accordingly, the time attenuation factor may be obtained by using an exponential attenuation function (π/2-arctan((t−T)/λ))/π on which arc tangent transformation is performed, where λ and T are parameters, λ may be used for controlling smoothness of the curve (a larger A indicates a smoother curve), T may be used for controlling an inflection point of the curve, and t is a time variable. The exponential attenuation function on which arc tangent transformation is performed is shown in FIG. 6.

For the current month, the weight corresponding to each day may be obtained after normalizing by substituting, into the exponential attenuation function on which arc tangent transformation is performed, the time attenuation factor that is obtained according to an interval to the current time. For the months before the current moment, a weight corresponding to the month may be obtained by adding a weight corresponding to each day in each month.

In step S1.3, a formula for calculating the score of the interaction type is: eⱼ=Σᵢ₌₁ⁿWⱼ*Sᵢ, where Wi is a weight corresponding to an i^{th} specified time, Sᵢ is a score corresponding to the i^{th} specified time, and eⱼ is a score of a j^{th} interaction type.

The simultaneous satisfaction degree of the interaction types in step S1.4 has simultaneity and substitutability. The simultaneity of the interaction types refers to that the interaction types need to simultaneously meet a condition, for example, all of the interaction types must be very active, and therefore, it can be considered that the user actively interacts with the contact. The substitutability of the interaction types refers to that it is only required that one or several of the interaction types meet the condition, for example, one or several of the interaction types are very active, and therefore, it can be considered that the user actively interacts with the contact. The simultaneous satisfaction degree of the interaction types may be adjusted according to a simultaneity parameter r in a continuous preference logic theory. The simultaneity parameter r is a conjunctive/disconjunctive coefficient of an aggregation module, and indicates logic preference of each module. When r=−∞, an aggregation operator is a pure conjunction, and simultaneity of each module is the strongest; and when r=+∞, the aggregation operator is a pure disjunction, and substitutability of each module is the strongest.

In an embodiment, according to the continuous preference logic theory, the simultaneity parameter r may be obtained with reference to the following table:

| Operation | Symbol | d | r2 | r3 | r4 | r5 |
|---|---|---|---|---|---|---|
| DISJUNCTION | D | 1.0000 | +infty | +infty | +infty | +infty |
| STRONG QD (+) | D++ | 0.9375 | 20.630 | 24.300 | 27.110 | 30.090 |
| STRONG QD | D+ | 0.8750 | 9.521 | 11.095 | 12.270 | 13.235 |
| STRONG QD (−) | D+− | 0.8125 | 5.802 | 6.675 | 7.316 | 7.819 |
| MEDIUM QD | DA | 0.7500 | 3.929 | 4.450 | 4.825 | 5.111 |
| WEAK QD (+) | D−+ | 0.6875 | 2.792 | 3.101 | 3.318 | 3.479 |
| WEAK QD | D− | 0.6250 | 2.018 | 2.187 | 2.302 | 2.384 |
| SQUARE MEAN | SQU | 0.6232 | 2.000 | | | |
| WEAK QD (−) | D−− | 0.5625 | 1.449 | 1.519 | 1.565 | 1.596 |
| ARITHMETIC MEAN | A | 0.5000 | 1.000 | 1.000 | 1.000 | 1.000 |
| WEAK QC (−) | C−− | 0.4375 | 0.619 | 0.573 | 0.546 | 0.526 |
| WEAK QC | C− | 0.3750 | 0.261 | 0.192 | 0.153 | 0.129 |
| GEOMETRIC MEAN | GEO | 0.3333 | 0.000 | | | |
| WEAK QC (+) | C−+ | 0.3125 | −0.148 | −0.208 | −0.235 | −0.251 |
| MEDIUM QC | CA | 0.2500 | −0.720 | −0.732 | −0.721 | −0.707 |
| HARMONIC MEAN | HAR | 0.2274 | −1.000 | | | |
| STRONG QC (−) | C+− | 0.1875 | −1.655 | −1.550 | −1.455 | −1.380 |
| STRONG QC | C+ | 0.1250 | −3.510 | −3.114 | −2.823 | −2.606 |
| STRONG QC (+) | C++ | 0.0625 | −9.060 | −7.639 | −6.689 | −6.013 |
| CONJUNCTION | C | 0.0000 | −infty | −infty | −infty | −infty |

In the foregoing table, 0≦d≦1, a smaller d indicates higher simultaneity of the interaction types, and a larger d indicates higher substitutability of the interaction types. Most commonly used values of d are 0, 1/16, . . . , and 1, and an aggregation operator and a value of r that correspond to each of the commonly used values of d are listed in the foregoing table. A method for determining the simultaneity parameter r by using the foregoing table may be: first determining a corresponding aggregation operator according to a requirement on the simultaneous satisfaction degree, and then finding, according to the number of variables (which refers to the number of the interaction types herein), a value of r corresponding to the aggregation operator. Because strong substitutability exists between the interaction types, it may be selected, for example, that d=0.7500, and a corresponding aggregation operator is a DA operator. The interaction types include three types, and it may be known by querying the foregoing table that a value of r corresponding to the DA operator is 4.450.

The preset weights of the interaction types may also be obtained by using the AHP. A formula of performing aggregation calculation on the scores of the interaction types with reference to the simultaneous satisfaction degree of the interaction types and the preset weights of the interaction types, to obtain the score e0 of the interaction activity is as follows:

e₀=L(e₁, . . . , eₖ)=(w₁e₁r+ . . . +wₖeₖ^{r})^{1/h};

0<wᵢ<1, w₁+ . . . +wₖ=1;

0≦eᵢ≦1, i=0, 1, . . . , k,

where L is an aggregation function, eᵢ is a score obtained by normalizing a score of an i^{th} interaction type to an interval of [0,1], k is the number of the interaction types, and wᵢ is a preset weight of the i^{th} interaction type.

In step S2, the relation chain type of the user and the contact is identified, and specifically, in step S2, the relation chain type of the user and the contact may be identified according to information keywords separately set by the user and the contact and a common contact between the user and the contact. Specifically, the information keyword includes a remark of the user on the contact, a keyword in a group name or a circle name to which the contact is added, a remark of the contact on the user, and a keyword in a group name or a circle name to which the user is added.

First, in step S2, one or more possible relation chain types of the user and the contact are preliminarily obtained according to the remark of the user on the contact, the group name, the circle name, and the like; then, in step S2, the preliminarily obtained one or more relation chain types are further filtered according to the number of common contacts, which are distributed in groups and circles, of the user and the contact, for example, it is preliminarily known that the user and the contact may be relatives, but no common contact of the user and the contact exists in a relative group of the user, so that a relation chain type that the user and the contact are relatives is filtered out; and finally, in step S2, one or more relation chain types obtained after filtering are further filtered according to the remark of the contact on the user, and a most possible relation chain type of the user and the contact is finally obtained.

In step S2, the score table includes a score corresponding to each preset relation chain type. The score corresponding to each preset relation chain type may also be obtained by using the AHP. In step S2, after the relation chain type of the user and the contact is identified, the score table may be queried to obtain the score of the relation chain type.

In step S3, the simultaneous satisfaction degree of the interaction activity and the relation chain type may also be adjusted by using the simultaneity parameter r. The simultaneity parameter r may also be determined according to the foregoing table. For example, if it is selected that d=0.7500, a corresponding aggregation operator is the DA operator, and the number of variables is 2, which are separately the interaction activity and the relation chain type, and it may be known by querying the foregoing table that a value of r corresponding to the DA operator is 3.929. The preset weights of the interaction activity and the relation chain type may also be obtained by using the AHP. A formula for calculating the score of the relational closeness between the user and the contact is as follows:

S=(w₁e₁^{r}+w₂e₂^{r})^{1/r},

where e₁ is a score obtained after the score of the interaction activity is normalized into the interval of [0,1], w1 is the preset weight of the interaction activity, e₂ is a score obtained after the score of the relation chain type is normalized into the interval of [0,1], and w₂ is a preset weight of the relation chain type.

In step S4, the contact is managed according to the score of the relational closeness between the user and the contact. Specifically, in an embodiment, if the score of the relational closeness is greater than a first threshold, it indicates that the relational closeness between the contact and the user is high, and the contact is recommended to the user to follow, which includes following a log posted by the contact, an uploaded photo, a comment, and the like. If the score of the relational closeness is less than a second threshold, it indicates that the relational closeness between the contact and the user is low, folding or deleting processing is performed on the contact, for example, the contact and another contact whose relational closeness with the user is low are transferred into a same group, and the user is informed that contacts in the group do not need to be followed, for example, a name of the group is set as “Stranger”, and dynamic statuses of all the contacts in the group are blocked.

Referring to FIG. 7, an embodiment of the present invention further provides a contact management apparatus 100, including a first calculation module 101, an identification module 102, a second calculation module 103, and a management module 104. It may be understood that, the modules refer to computer programs or program segments, and are configured to perform one or more specific functions. In addition, distinguishing the modules does not indicate that actual program code also must be distinguished.

The first calculation module 101 is configured to calculate a score of interaction activity between a user and a contact according to an interaction measure, interaction frequency, a time attenuation factor, and a preset weight of each interaction type of the user and the contact, and a simultaneous satisfaction degree of interaction types. The interaction types include a one-to-one interaction, a one-to-many interaction, and a social site interaction.

Specifically, first, the first calculation module 101 separately calculates, according to the interaction measure and the interaction frequency of each interaction type, a score corresponding to the interaction type in each specified time.

Then, the first calculation module 101 separately calculates, according to the time attenuation factor of each interaction type, a weight corresponding to the interaction type in each specified time.

Next, the first calculation module 101 separately calculates a score of each interaction type according to the score corresponding to the interaction type in each specified time and the weight corresponding to the specified time.

Finally, the first calculation module 101 performs aggregation calculation on the scores of the interaction types with reference to the simultaneous satisfaction degree of the interaction types and the preset weights of the interaction types, to obtain the score of the interaction activity. The preset weights of the interaction types may be obtained by using an AHP.

The identification module 102 is configured to identify a relation chain type of the user and the contact, and query a preset score table to obtain a score of the relation chain type. The identification module 102 identifies the relation chain type of the user and the contact according to information keywords separately set by the user and the contact and a common contact of the user and the contact. The preset score table includes a score corresponding to each preset relation chain type. The score corresponding to the preset relation chain type may also be obtained by using the AHP.

The second calculation module 103 is configured to calculate a score of relational closeness between the user and the contact according to the score of the interaction activity and the score of the relation chain type with reference to a simultaneous satisfaction degree of the interaction activity and the relation chain type, and preset weights of the interaction activity and the relation chain type.

The management module 104 is configured to manage the contact according to the score of the relational closeness. Specifically, if the score of the relational closeness is greater than a first threshold, the management module 104 recommends the contact to the user to follow. If the score of the relational closeness is less than a second threshold, the management module 104 performs folding or deleting processing on the contact.

For specific working processes of the modules, reference may further made to the contact management method provided by the embodiments of the present invention, and details are not provided herein again.

To sum up, the contact management apparatus 100 in this embodiment obtains interaction activity between a user and a contact by comprehensively considering an interaction measure, interaction frequency, and a time attenuation effect of each interaction type of the user and the contact, and a simultaneous satisfaction degree of the interaction types; measures relational closeness between the user and the contact with reference to a simultaneous satisfaction degree of a relation chain type of the user and the contact and the interaction activity; and manages the contact according to the relational closeness, which can help the user tease out a social relation chain, so as to facilitate information recommendation to the user.

In addition, an embodiment of the present invention further provides a computer readable storage medium, in which a computer executable instruction is stored, and the foregoing computer readable storage medium is, for example, a non-volatile memory, such as an optical disc, a hard disk, or a flash memory. The computer executable instruction is used for enabling a computer or a similar computing apparatus to perform various operations in the contact management method.

The foregoing descriptions are merely preferred embodiments of the present invention, and are not intended to limit the present disclosure in any form. Although the present disclosure has been disclosed above through the preferred embodiments, the embodiments are not intended to limit the present disclosure. A person skilled in the art can make some equivalent variations, alterations or modifications to the above-disclosed technical content without departing from the scope of the technical solutions of the present disclosure to obtain equivalent embodiments. Any simple alteration, equivalent change or modification made to the foregoing embodiments according to the technical essence of the present disclosure without departing from the content of the technical solutions of the present disclosure shall fall within the scope of the technical solutions of the present disclosure.

What is claimed is:

1. A contact management method, applied to a server, the server comprising one or more processors, a memory, and a program instruction stored in the memory, and the program instruction being executed by the one or more processors, and comprising:
calculating a score of interaction activity between a user and a contact according to an interaction measure, interaction frequency, a time attenuation factor, and a preset weight of each interaction type of the user and the contact, and a simultaneous satisfaction degree of the interaction types;
identifying a relation chain type of the user and the contact, and querying a preset score table to obtain a score of the relation chain type;
calculating a score of relational closeness between the user and the contact according to the score of the interaction activity and the score of the relation chain type with reference to a simultaneous satisfaction degree of the interaction activity and the relation chain type, and preset weights of the interaction activity and the relation chain type; and
managing the contact according to the score of the relational closeness.

2. The method according to claim 1, wherein the interaction types comprise a one-to-one interaction, a one-to-many interaction, and a social site interaction.

3. The method according to claim 1, wherein the step of calculating a score of interaction activity between a user and a contact according to an interaction measure, interaction frequency, a time attenuation factor, and a preset weight of each interaction type of the user and the contact, and a simultaneous satisfaction degree of the interaction types comprises:
calculating, according to the interaction measure and the interaction frequency of each interaction type, a score corresponding to the interaction type in each specified time;
calculating, according to the time attenuation factor of each interaction type, a weight corresponding to the interaction type in each specified time;
calculating a score of each interaction type according to the score corresponding to the interaction type in each specified time and the weight corresponding to the specified time; and
performing aggregation calculation on the scores of the interaction types with reference to the simultaneous satisfaction degree of the interaction types and the preset weights of the interaction types, to obtain the score of the interaction activity.

4. The method according to claim 3, wherein the preset weight of each interaction type is obtained by using an analytic hierarchy process (AHP).

5. The method according to claim 1, wherein the identifying a relation chain type of the user and the contact comprises:
identifying the relation chain type of the user and the contact according to information keywords separately set by the user and the contact and a common contact between the user and the contact.

6. The method according to claim 1, wherein the preset score table comprises a score corresponding to each preset relation chain type.

7. The method according to claim 6, wherein the score corresponding to the preset relation chain type is obtained by using an AHP.

8. The method according to claim 1, wherein the managing the contact according to the score of the relational closeness comprises:
recommending, if the score of the relational closeness is greater than a first threshold, the contact to the user to follow; and
performing folding or deleting processing on the contact if the score of the relational closeness is less than a second threshold.

9. A contact management apparatus, comprising:
one or more processors;
a memory; and
one or more program modules, stored in the memory, and executed by the one or more processors, the one or more program modules comprising:
a first calculation module, configured to calculate a score of interaction activity between a user and a contact according to an interaction measure, interaction frequency, a time attenuation factor, and a preset weight of each interaction type of the user and the contact, and a simultaneous satisfaction degree of the interaction types;
an identification module, configured to identify a relation chain type of the user and the contact, and query a preset score table to obtain a score of the relation chain type;
a second calculation module, configured to calculate a score of relational closeness between the user and the contact according to the score of the interaction activity and the score of the relation chain type with reference to a simultaneous satisfaction degree of the interaction activity and the relation chain type, and preset weights of the interaction activity and the relation chain type, and; and
a management module, configured to manage the contact according to the score of the relational closeness.

10. The apparatus according to claim 9, wherein the interaction types comprise a one-to-one interaction, a one-to-many interaction, and a social site interaction.

11. The apparatus according to claim 9, wherein the first calculation module is configured to:
calculate, according to the interaction measure and the interaction frequency of each interaction type, a score corresponding to the interaction type in each specified time;
calculate, according to the time attenuation factor of each interaction type, a weight corresponding to the interaction type in each specified time;
calculate a score of each interaction type according to the score corresponding to the interaction type in each specified time and the weight corresponding to the specified time; and
perform aggregation calculation on the scores of the interaction types with reference to the simultaneous satisfaction degree of the interaction types and the preset weights of the interaction types, to obtain the score of the interaction activity.

12. The apparatus according to claim 11, wherein the preset weight of each interaction type is obtained by using an analytic hierarchy process (AHP).

13. The apparatus according to claim 9, wherein the identifying a relation chain type of the user and the contact comprises:
identifying the relation chain type of the user and the contact according to information keywords separately set by the user and the contact and a common contact between the user and the contact.

14. The apparatus according to claim 9, wherein the preset score table comprises a score corresponding to each preset relation chain type.

15. The apparatus according to claim 14, wherein the score corresponding to the preset relation chain type is obtained by using an AHP.

16. The apparatus according to claim 9, wherein the management module is configured to:
recommend, if the score of the relational closeness is greater than a first threshold, the contact to the user to follow; and
perform folding or deleting processing on the contact if the score of the relational closeness is less than a second threshold.

17. A non-transitory computer readable storage medium, storing computer executable instructions, and when the executable instructions are executed in a server, performing a contact management method, the method comprising:
calculating a score of interaction activity between a user and a contact according to an interaction measure, interaction frequency, a time attenuation factor, and a preset weight of each interaction type of the user and the contact, and a simultaneous satisfaction degree of the interaction types;
identifying a relation chain type of the user and the contact, and querying a preset score table to obtain a score of the relation chain type;
calculating a score of relational closeness between the user and the contact according to the score of the interaction activity and the score of the relation chain type with reference to a simultaneous satisfaction degree of the interaction activity and the relation chain type, and preset weights of the interaction activity and the relation chain type; and
managing the contact according to the score of the relational closeness.
